(19) United States
(12) Patent Application Publication
(10) Pub. No.: US 2005/0220468 A1
(43) Pub. Date: Oct. 6, 2005

(54) Image forming apparatus

(75) Inventor: Kenichiro Kitajima, Toride-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/085,562

(22) Filed: Mar. 22, 2005

(30) Foreign Application Priority Data
Mar. 26, 2004 (JP) 091628/2004(PAT.)

(51) Int. Cl. G03G 15/00; G03G 15/02

(52) U.S. Cl. 399/48; 399/50

(57) ABSTRACT

An image forming apparatus includes a rotatable image bearing member; charging means for electrically charging the image bearing member; exposure means for exposing the image bearing member charged by the charging means to light at an exposure position to form an electrostatic latent image; pre-exposure potential detecting means for detecting a potential on the image bearing member before exposure to the light, the pre-exposure potential detecting means being disposed at a position downstream of the charging means and upstream of the exposure position with respect to a rotational direction of the image bearing member; and potential adjusting means for adjusting the potential on the image bearing member before the exposure on the basis of an output of the potential detecting means, the potential adjusting means being disposed downstream of the pre-exposure potential detecting means and upstream of the exposure position with respect to the rotational direction of the image bearing member.

### FIELD OF THE INVENTION AND RELATED ART

The present invention relates to an electrophotographic image forming apparatus such as a printer, a copying machine, a facsimileing machine, etc.

The image forming operation of an electrophotographic image forming apparatus such as a printer, a copying machine, a facsimileing machine, etc., has been as follows: The data regarding the gradation of each of the picture elements obtained with the use of a predetermined image processing method are converted into optical signals. The optical signals are reflected by an optical scanning system comprising a rotating polygon mirror, etc., so that the charged peripheral surface of a photosensitive drum (photosensitive member) is raster scanned to remove the electric charge from the exposed points of the peripheral surface of the photosensitive drum. As a result, an electrostatic latent image is formed.

After the formation of the electrostatic latent image, toner is adhered by a developing apparatus to the peripheral surface of the photosensitive drum in the pattern of the latent image; the latent image is developed into an image formed of toner (which hereinafter will be referred to as toner image). The toner image is transferred by a transferring apparatus onto recording medium (paper, transparent film, etc.), and then, is fixed by a fixing apparatus to the recording medium, yielding thereby a permanent image (copy).

As for the technologies for stabilizing an electrophotographic image forming apparatus in terms of image density, there has been known the technology that rectifies the image forming apparatus in image quality by adjusting its image bearing member in development contrast potential level, and/or by measuring the density of a toner image formed on a recording medium, a photosensitive drum, or an intermediary transfer member, in accordance with video signals, and adjusting the gradation LUT (look-up table) in accordance with the obtained toner image density.

This technology suffers from the following problems: When the peripheral surface of a photosensitive drum is nonuniform in potential level and/or uneven in peripheral surface, in terms of the direction parallel to its axial line, the points of the peripheral surface of the photosensitive drum, at which the density of the image (toner image) is measured, are different in potential level from the other points, which results in the errors in the correction of the LUT, and therefore, it is impossible to rectify the image forming apparatus in image density in general and halftone density in particular, in order to form an image which is right on target in terms of image density in general as well as halftone density.

In order to achieve an intended density level in response to the video signals, it is essential to reduce the peripheral surface of the photosensitive drum of the image forming apparatus, in the nonuniformity in the potential level of a latent image.

The nonuniformity in the potential level of the peripheral surface of a photosensitive drum is essentially attributable to two of the various properties of the photosensitive drum: potential level to which the peripheral surface of the photosensitive drum is charged, and attenuation of the potential. Referring to FIG. 5, as a photosensitive drum, the peripheral surface of which is nonuniform in potential level in terms of the direction parallel to the axial line of the photosensitive drum, is rotated once while being scanned, across its peripheral surface, in the direction parallel to the axial line of the photosensitive drum, by the beam of light, the intensity of which is equivalent to the halftone density, the potential level of the peripheral surface of the photosensitive drum becomes as shown in FIG. 5, which shows the nonuniformity of the potential level of the peripheral surface of the photosensitive drum. Incidentally, in FIG. 5, the peripheral surface of the cylindrical photosensitive drum has been cut along a line parallel to the generatrix thereof, and has been developed in its rotational direction.

It is evident from FIG. 5 that the nonuniformity in potential level of the peripheral surface of the photosensitive drum has a three dimensional profile independent from the direction in which the photosensitive drum is rotated, and the direction parallel to the axial line of the photosensitive drum. This profile regarding the nonuniformity in potential level is attributable to the aforementioned properties of the photosensitive drum; the peripheral surface of the photosensitive drum is nonuniform in the potential level of its VD points (areas) as well as the potential level of the VL points (areas). When the peripheral surface of the photosensitive drum nonuniform in potential level as described above is exposed, the potential level of the peripheral surface of the photosensitive drum changes in accordance with the amount of exposure, as shown in FIG. 9 (nonuniformity in terms of E-V property).

FIG. 9 is a graph obtained by plotting the average values of the potential level detected at a plurality of points of the peripheral surface of the photosensitive drum, in terms of the direction parallel to the axial line of the photosensitive drum (which hereinafter may be referred to as lengthwise direction), while the photosensitive drum is rotated once. In the graph, each line is different in the amount of exposure from the other, and the potential level values plotted for each of the various exposure amounts are the average of the potential level values detected at each of the plurality of potential level detection points while the photosensitive drum is rotated. The horizontal axis represents the points of the peripheral surface of the photosensitive drum, at which the potential level is detected, and which is expressed in terms of the distance from the lengthwise midpoint of the photosensitive drum. Referential symbols F and R stand for the front and rear sides of the image forming apparatus with respect to the lengthwise midpoint of the photosensitive drum. In other words, F(50), F(90), F(130), and F(150) mean 50 mm, 90 mm, 130 mm, and 150 mm frontward from the midpoint, and R(50), R(90), R(130), and R(150) mean 50 mm, 90 mm, 130 mm, and 150 mm rearward from the midpoint, respectively. Further, each of the plurality of lines shows the nonuniformity in potential level, which resulted as the charged peripheral surface of the photosensitive drum was exposed to the beam of laser light, the intensity of which corresponded to the values 0, 32, 64, 96, 128, 176, 208, 240, and 256 among the 256 video signal levels. Incidentally, Vd stands for the potential level of any of the unexposed points of the peripheral surface of the photosensitive drum.

It is evident from FIG. 9 that the axial nonuniformity, in potential level, of the photosensitive drum (nonuniformity in terms of direction parallel to drum axis, whereas nonuniformity in terms of direction parallel to circumferential direction of photosensitive drum will be referred to hereafter as circumferential nonuniformity) slightly varies in profile, depending on potential level; it is not uniform also in the VD potential level.

The nonuniformity of the photosensitive drum in the VD potential level, which is attributable to the nonuniformity of the photosensitive drum in the chargeability in terms of the circumferential direction thereof, the nonuniformity of the charging means in charging performance in terms of the lengthwise directions thereof, is present during the initial stage of charging process, and also, is caused by the changes, for example, the fatigue, which occur to the charging means or/and photosensitive drum with usage and the passage of time.

The relationship (E-V characteristic) between the amount by which the photosensitive drum is exposed and the resultant potential level of the photosensitive drum is shown in FIG. 10. The relationship shown in FIG. 10 is obtained from a test which used a photosensitive drum, the photosensitive layer of which is formed of amorphous silicon. Therefore, the relationship is characterized in that it is linear, unlike the nonlinear relationship, which is usual when the photosensitive layer of a photosensitive drum is formed of organic photo-conductor.

However, even a photosensitive drum linear in E-V characteristic is nonuniform in sensitivity in terms of the direction parallel to its axis. FIG. 10 shows the substantial changes in the circumferential nonuniformity of the photosensitive drum in the E-V characteristic and the axial nonuniformity in potential level, which occurred as the amount, by which the charged photosensitive drum (with VD potential level) was exposed, was increased.

In order for the image forming apparatus to be stable in image density across the lowest to highest ends of the image density range, it is essential that the image forming apparatus is stable in the potential level (VD potential level) to which the photosensitive drum is charged, and the potential level (VL potential level) to which a given point of the peripheral surface of the photosensitive drum is reduced in potential as it is exposed to an optical signal, to which a video signal is converted, to form an electrostatic latent image.

The following are the methods, in accordance with the prior arts, for correcting an image forming apparatus in the VD potential level, VL potential level, and VH potential level which corresponds to the halftone portions of an image.

As for the method, proposed by Japanese Laid-open Patent Application 6-282143, for correcting an image forming apparatus in potential level, the image forming apparatus is provided with a sensor capable of detecting the rotational phase of the photosensitive drum, and the difference between the average potential level of the photosensitive drum across the entire functional range of the photosensitive drum in terms of the circumferential direction of the photosensitive drum, and the average potential level of each of a plurality of areas of the same size, into which the peripheral surface of the photosensitive drum is divided, is calculated, and the obtained values are stored as potential level deviation values. Then, the charging means and exposing means are adjusted in accordance with the potential level deviation value of each area.

As for the method proposed by Japanese Laid-open Patent Application 3-243967, the image forming apparatus is provided with an optically transmissive member, the transmissivity of which can be adjusted by adjusting the voltage applied thereto, and which is disposed in the path of the beam of light for exposing the photosensitive drum. The potential level of the photosensitive drum is measured across the entire functional range of the peripheral surface of the photosensitive drum in terms of the circumferential direction, with a potential sensor moved by a predetermined distance per rotation of the photosensitive drum, in order to obtain the potential level deviation profile of each of the areas of the same size, into which the peripheral surface of the photosensitive drum is divided in terms of the axial direction of the photosensitive drum. Thus, the image forming apparatus is corrected in the potential level by adjusting the amount of the light to which the peripheral surface of the photosensitive drum is exposed.

Further, as for the method proposed in Japanese Laid-open Patent Application 9-258505, the image forming apparatus is provided with a plurality of optical shutters, a plurality of flat light emitting elements, and a plurality of means for detecting surface potential level of the photosensitive drum. The optical shutters are disposed on one of the primary surfaces of the substrate, on which the image writing head is formed, and the light emitting elements are disposed on the opposite primary surface. Thus, each of the plurality of sections of the peripheral surface of the photosensitive drum is controlled in potential level by independently controlling the charging means, and the means for controlling the amount of the exposure light, based on the results from the measurement of the potential level by the surface potential level detecting means.

The above described arts disclosed in the abovementioned documents are such arts that detect the potential level of the photosensitive drum with the use of a potential level detecting means, and corrects the image forming apparatus only in the post-exposure potential level (potential level of exposed portion). Thus, basically, these arts, that is, these methods for correcting the image forming apparatus in the VL potential level is effective when the photosensitive drum is stable (uniform) in the VD potential level, but, nonuniform in the VL potential level, in terms of the axial direction of the photosensitive drum.

Referring to FIG. 12, as long as the photosensitive drum is uniform in the VD potential level, the photosensitive drum can be made uniform in the gradation potential level which is dependent on a video signal, by adjusting the amount, by which the photosensitive drum is exposed, at the points A and B, in accordance with the exposure characteristic of the photosensitive drum across its range in the direction parallel to the drum axis, so that the photosensitive drum becomes uniform in the VL potential level. Therefore, it is possible to correct the photosensitive drum in the VL potential level so that the relationship between the video signal and resultant image density becomes uniform across the functional range of the photosensitive drum in terms of the direction parallel to the drum axis.

However, if the exposure amount is adjusted, as described in the abovementioned patent documents, to make the photosensitive drum uniform in the VL potential level when the photosensitive drum is nonuniform in the VD potential level in terms of the direction parallel to the drum axis, the deviation in the image density level corresponding to the halftone effected by video signals, and the deviation in the maximum image density effected by video signals, remain at the points A and B, in spite of the exposure amount adjustment, because of the nonuniformity in the VD potential level.

In this condition, the photosensitive drum is nonuniform in the potential level corresponding to halftone, and the potential level close to the VD potential level. Therefore, the photosensitive drum becomes nonuniform, in terms of the direction parallel to the drum axis, in the density effected by video signals.

In order to make the photosensitive drum uniform in potential level in the above described condition, it is necessary to adjust the laser in output according to the properties of video signals, and/or to adjust the gradation density; in other words, it is necessary to carry out very complicated control.

Thus, in order to minimize the photosensitive drum in the nonuniformity in the post-exposure potential level, it is desired to minimize the photosensitive drum in the nonuniformity in the potential level (VD potential level) to which the photosensitive drum is charged. Japanese Patent Application Publication 5-25112 discloses a structural arrangement in which a potential level detecting means for detecting the potential level of an image bearing member immediately after the charging of the image bearing member by the charging means is disposed between the charging means for charging the image bearing member and the exposing means for exposing the image forming member to form an electrostatic latent image on the image bearing member, and also, in which a potential level adjusting means for adjusting the image bearing member in potential level immediately after the charging of the image bearing member is disposed upstream of the potential level detecting means, and downstream of the charging means, in terms of the moving direction of the peripheral surface of the image bearing member.

However, this structural arrangement suffers from the following problem because of the above described positional relationship between the potential level detecting means and potential level adjusting means. That is, because the potential level adjusting means is located upstream of the potential level detecting means in terms of the rotational direction of the image bearing member, it takes a long time for a given point of the peripheral surface of the image bearing member, which is to be corrected in potential level, to reach the potential level adjusting means after passing by the potential level detecting means. Therefore, the length of time from the starting of the charging step to the starting of the exposing step is long.

### SUMMARY OF THE INVENTION

The primary object of the present invention is to reduce the length of time between the detection of the potential level to which an object has been charged and the completion of the correction of the object in potential level.

Another object of the present invention is to minimize an image bearing member in the nonuniformity in the potential level corresponding to the halftone (in gradation), by making the image bearing member uniform in both the pre-exposure potential level and post-exposure potential level.

According to an aspect of the present invention, there is provided an image forming apparatus comprising a rotatable image bearing member; charging means for electrically charging said image bearing member; exposure means for exposing said image bearing member charged by said charging means to light at an exposure position to form an electrostatic latent image; pre-exposure potential detecting means for detecting a potential on said image bearing member before exposure to the light, said pre-exposure potential detecting means being disposed at a position downstream of said charging means and upstream of the exposure position with respect to a rotational direction of said image bearing member; and potential adjusting means for adjusting the potential on said image bearing member before the exposure on the basis of an output of said potential detecting means, said potential adjusting means being disposed downstream of said pre-exposure potential detecting means and upstream of the exposure position with respect to the rotational direction of said image bearing member.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic drawing of the image forming apparatus compatible with the present invention, showing the general structure thereof.

FIG. 2 is a schematic drawing of the potential level adjusting means, showing the structure thereof.

FIG. 3 is a schematic drawing showing the second potential level detecting means.

FIG. 4 is a diagrammatic drawing showing the characteristic of the photosensitive drum regarding the gradation, after photosensitive drum was corrected in both the VD and VL potential levels when the photosensitive drum was nonuniform in the VD potential level.

FIG. 5 is a graph showing the profile of the photosensitive drum regarding the nonuniformity in potential level, in terms of the rotational as well as axial directions of the photosensitive drum.

FIG. 6 is a flowchart for adjusting the photosensitive drum in pre-exposure potential level.

FIG. 7 is a flowchart for adjusting the photosensitive drum in pre-exposure potential level.

FIG. 8 is a flowchart for adjusting the amount by which the photosensitive drum is exposed.

FIG. 9 is a graph profiling the nonuniformity of the photosensitive drum regarding the potential level in terms of the circumferential as well as axial direction.

FIG. 10 is a graph showing the relationship between the E-V characteristic in FIG. 1.

FIG. 11 is a diagrammatic drawing depicting the nonuniformity in the VD potential level in terms of the axial direction of the photosensitive drum, when the photosensitive drum is uniform in the VL potential level.

FIG. 12 is a diagrammatic drawing depicting the characteristic of the photosensitive drum with respect to gradation, after the correction of the photosensitive drum in the VL potential level when the photosensitive drum is uniform in the VD potential level.

FIG. 13 is a diagrammatic drawing depicting the characteristic of the photosensitive drum with respect to gradation, after the correction of the photosensitive drum in the VL potential level, when the photosensitive drum is nonuniform in the VD potential level.

### DETAILED DESCRIPTION OF THE PREFERRED EMBODIMENTS

Hereinafter, the preferred embodiments of the present invention will be described with reference to the appended drawings. When a given component in one drawing has the same referential symbol as a given component in another drawing, the two components are the same in structure and function, and therefore, once the given component is described, it will not be described again.

<Embodiment 1>

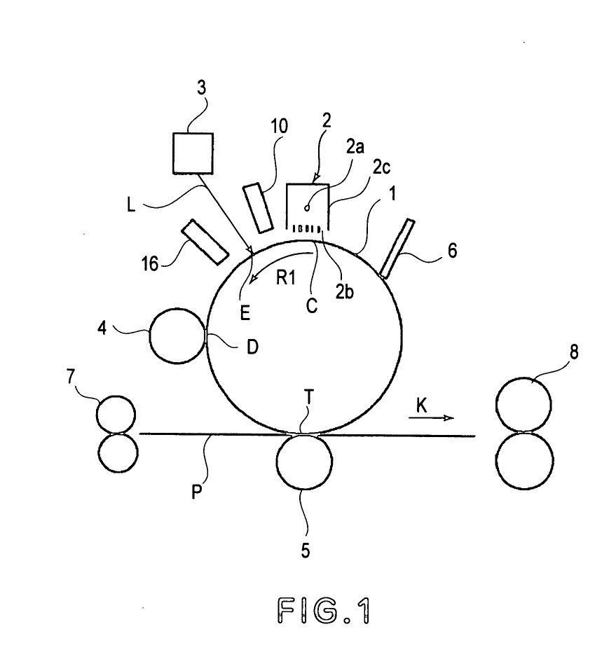

FIG. 1 is a schematic drawing of a typical image forming apparatus to which the present invention is applicable. In this embodiment, the present invention regarding the correction of the photosensitive drum in the post-exposure potential level will be described with reference to an image forming apparatus of the background exposure type, which forms an image by exposing the numerous points of the peripheral surface of the photosensitive member, which correspond to the background portions of an intended image, with the beam of light modulated with digitally processed video signals. This method of forming an image by the background exposure is similar to the analog image forming apparatus. That is, an electrostatic latent image is formed by exposing the portions of the peripheral surface of the photosensitive member, which correspond to the background portions of an intended image, and the electrostatic latent image is developed into a visible image formed of toner, with the use of the normal developing method. However, this embodiment is not intended to limit the application of the present invention to an image forming apparatus of the background exposure type; the present invention is also compatible with an image forming apparatus employing the widely used reversal developing method, which adheres toner to the exposed portions.

The image forming apparatus in FIG. 1 has an electrophotographic photosensitive member (which hereinafter will be referred to simply as photosensitive member) as an image bearing member in the form of a drum. It also has a charging apparatus 2 (charging means), an exposing apparatus 3 (exposing means), a developing apparatus 4 (developing means), a transferring member 5 (transferring means), a cleaning apparatus 6 (cleaning means), etc., which are disposed in the adjacencies of the peripheral surface of the photosensitive drum 1 in a manner to surround the photosensitive drum 1. The image forming apparatus also has a means (unshown) for feeding and conveying recording medium into the main assembly of the image forming apparatus, a pair of registration rollers 7, a fixing apparatus 8 (fixing means), etc., listing from the upstream side in terms of the direction (indicated by arrow mark K) in which a recording medium P is conveyed.

As for the operation of the image forming apparatus structured as described above, the photosensitive drum 1 is rotationally driven by a driving means (unshown) at a predetermined process speed in the direction indicated by an arrow mark R1, and as it is driven, its peripheral surface is uniformly charged to predetermined polarity and potential level by the charging apparatus 2 in the charging portion C (charging portion). The charged peripheral surface of the photosensitive drum 1 is exposed at an exposing portion E (exposure portion) to a beam of light L projected from the exposing apparatus 3 while being modulated with image formation data. As a result, electrical charge is removed from the exposed points of the peripheral surface of the photosensitive drum 1, effecting an electrostatic latent image. This electrostatic latent image is developed into an image formed of toner (which hereinafter will be referred to as toner image), by the developing apparatus 4; toner is adhered to the peripheral surface of the photosensitive drum 1 in the pattern of the electrostatic latent image, by the developing apparatus 4 in the developing portion D (developing portion). The toner image is transferred by the transferring apparatus 5 (transferring means) onto the recording P, which is fed into the main assembly of the image forming apparatus by the recording medium feeding means, is conveyed to the pair of registration rollers 7 by the conveying means, and then, is released by the pair of registration rollers 7 to the transferring apparatus 5. After the transfer of the toner image, the photosensitive drum 1 is cleared by the cleaning apparatus 6 of the toner remaining on the peripheral surface of the photosensitive drum 1. Also after the transfer of the toner image, the recording medium P is conveyed to the fixing apparatus 8. In the fixing apparatus 8, the recording medium P and the toner image thereon are subjected to heat and pressure. As a result, the toner image is permanently fixed to the surface of the recording medium P, ending the process of forming a permanent image on the recording medium P.

The image forming apparatus in this embodiment is also provided with: a plurality of first potential level detecting means 11, as means for detecting the pre-exposure potential level of the peripheral surface of the photosensitive drum 1, which are disposed in the adjacencies of the peripheral surface of the photosensitive drum 1, on the downstream of the charging portion C and upstream of the exposing portion E (exposure point), in term of the rotational direction (indicated by arrow mark R1) of the photosensitive drum 1; a plurality of potential level adjusting means 10, which are disposed on the downstream of the first potential level detecting means 11 and upstream of the exposing portion E; and a plurality of second potential level detecting means 16, which are disposed downstream of the exposing portion E and upstream of the developing portion D, in FIG. 1. The second potential level detecting means 16 will be described later.

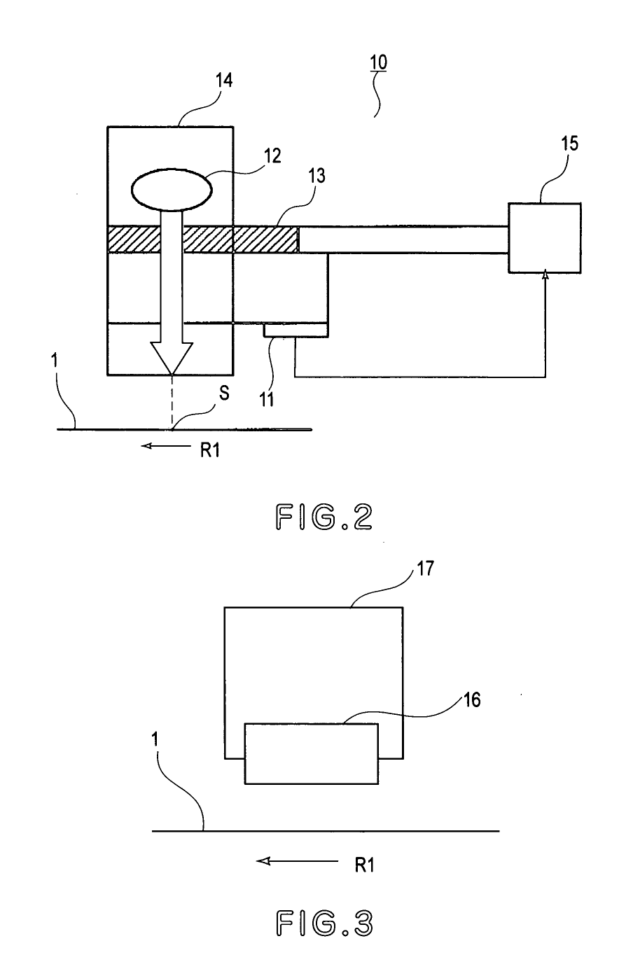

Referring to FIG. 2, the abovementioned potential level adjusting means 10 has a light emitting portions 12, a variable transmissivity filter 13, a supporting member 14 which supports the preceding two components 12 and 13, and a transmissivity controlling means 15. In this embodiment, the potential level adjusting means 10 is integral with the first potential level detecting means 11. However, it may be independent from the first potential level detecting means 11.

As the first potential level detecting means 11, a small potential level sensor may be employed. A conventional potential level sensor is too large to be linearly disposed in plurality in the direction parallel to the axial line of the photosensitive drum 1. In comparison, the potential level sensor in this embodiment is roughly 5 mm in length; the recent progress in semiconductor manufacturing technologies has made it possible to reduce in size the chopper portion of a conventional potential level sensor. In other words, the image forming apparatus in this embodiment is provided with a plurality of potential level sensor substantially smaller in size than a conventional potential level sensor. However, this embodiment is not intended to limit the scope of the present invention. That is, as far as the present invention is concerned, the type and structure of the potential level sensor is optional. The present invention is compatible with any potential level sensor as long as it can be linearly disposed in plurality in the direction parallel to the axial line of the photosensitive drum to detect the potential level of the peripheral surface of the photosensitive drum at a plurality of points, and is excellent in response. The plurality of potential level sensors as the first potential level detecting means 11 are disposed on the downstream of the charging portion C and upstream of the illumination point S (FIG. 2), with respect to the rotational direction of the photosensitive drum 1. Here, the illumination point S means the point at which the peripheral surface of the photosensitive drum 1 is illuminated by the light emitted from the light emitting portion 12, which will be described later, and transmitted through the variable transmissivity filter 13.

The light emitting portion 12 is used for correcting the photosensitive drum 1 in potential level prior to the exposure. As the light emitting portion 12, a long and narrow LED such as the one ubiquitously used in the field of an electrophotographic image forming apparatus may be employed. It is to be disposed so that it extends in the direction parallel to the axial direction of the photosensitive drum 1 (direction parallel to drum generatrix). The wavelength of the light emitting portion 12 has only to be selected in accordance with the spectral sensitivity of the photosensitive drum 1. In this embodiment, an LED with a wavelength of 660 nm is employed; it is the same in wavelength as the laser scanner used as the exposing apparatus 3 for exposing the photosensitive drum 1.

The variable transmissivity filter 13 is disposed between the above described light emitting portion 12 and photosensitive drum 1, so that the light emitted by the light emitting portion 12 is projected onto the peripheral surface of the photosensitive drum 1 through the variable transmissivity filter 13. The variable transmissivity filter 13 is disposed so that it extends in the direction parallel to the axial line of the photosensitive drum 1 (direction parallel to drum generatrix), and is enabled to be adjusted in transmissivity at any point in its functional range in terms of the direction parallel to the axial line of the photosensitive drum 1. In other words, the variable transmissivity filter 13 is adjustable in transmissivity so that the numerous points of the variable transmissivity filter 13 across its entire range in terms of the direction parallel to the axial line of the photosensitive drum 1 are uniformly or nonuniformly changed in transmissivity level.

As the variable transmissivity filter 13, a liquid crystal shutter can be employed. In recent years, a liquid crystal shutter has come down in cost. In other words, it has ceased to be a rare commodity, and therefore, has come to be widely used. A liquid crystal shutter can be controlled in transmissivity at specific points or across specific areas, with the use of optional control signals such as graphic signals displayable on a liquid crystal display, and is widely used in the field of a picture taking apparatus other than the field of electrophotography.

The following is the manner in which the liquid crystal shutter is controlled in transmissivity at a specific point or across a specific area: The photosensitive drum 1 is measured in potential level across its entire functional range in terms of the direction parallel to its axial line, obtaining the potential levels of the predetermined points of the peripheral surface of the photosensitive drum 1 (nonuniformity in pre-exposure potential level is detected) . Then, the transmissivity control map is created (computed) based on the detected potential level values, with predetermined timing. This transmissivity control map is transmitted as necessary to the liquid filter transmissivity controlling means 15 to continuously control the liquid crystal shutter in transmissivity at a specific point or a specific area, in terms of the direction parallel to the drum axis, as patterns are displayed on a liquid crystal display.

Next, the method for correcting the photosensitive drum 1 in the pre-exposure potential level deviation (VD potential level deviation) by the potential level adjusting means 10 structured as described above will be described.

Referring to FIG. 1, the charging apparatus 2 in this embodiment is a Scorotron, or a corona discharger, having a discharge wire 2a, a grid 2b, and a shield 2c. As for the working of this charging device, the discharge wire 2a is kept at a predetermined voltage level. The grid 2b and shield 2c are kept at the same potential level. The potential level to which the peripheral surface of the photosensitive drum 1 is to be charged can be controlled by controlling the high voltage of the grid 2b.

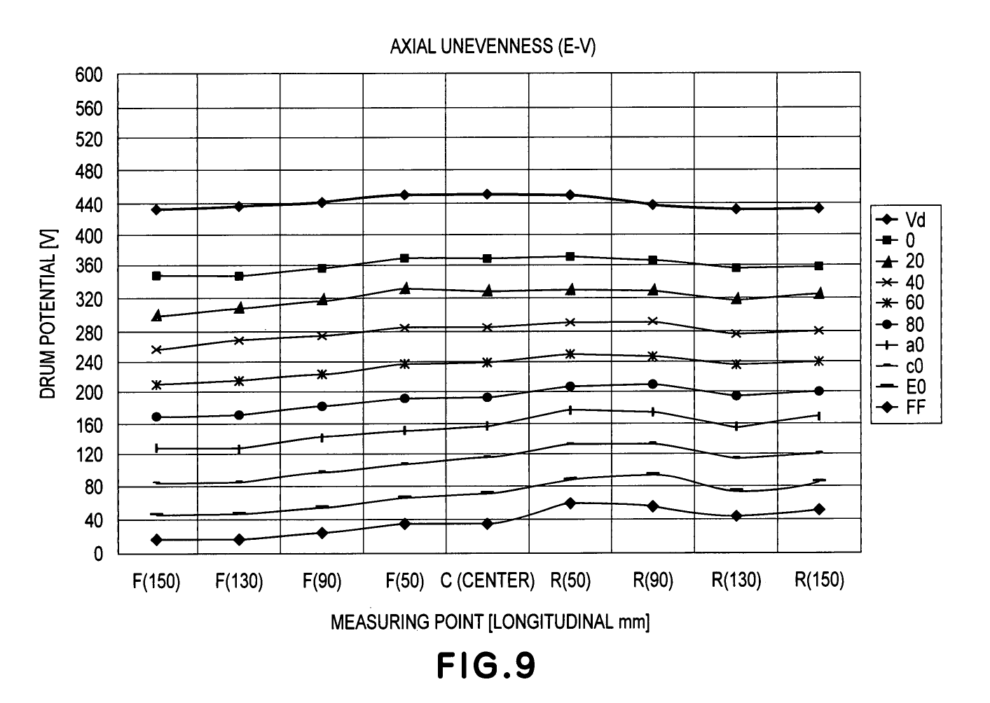

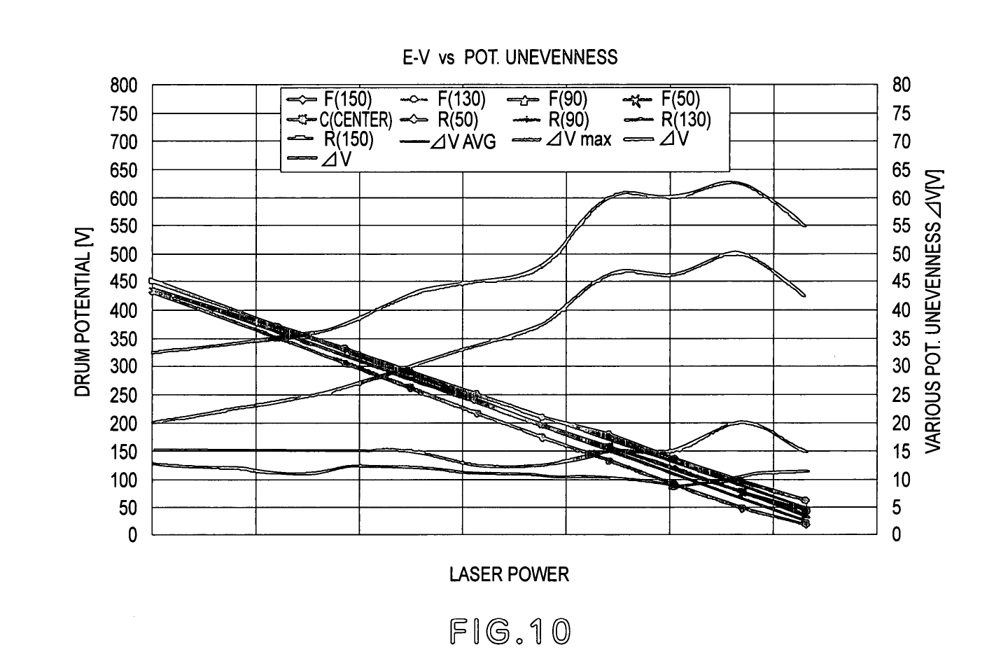

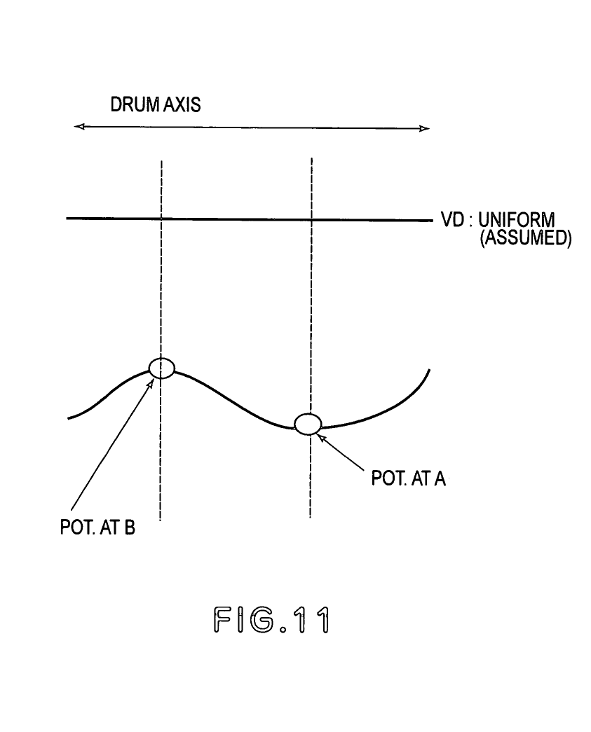

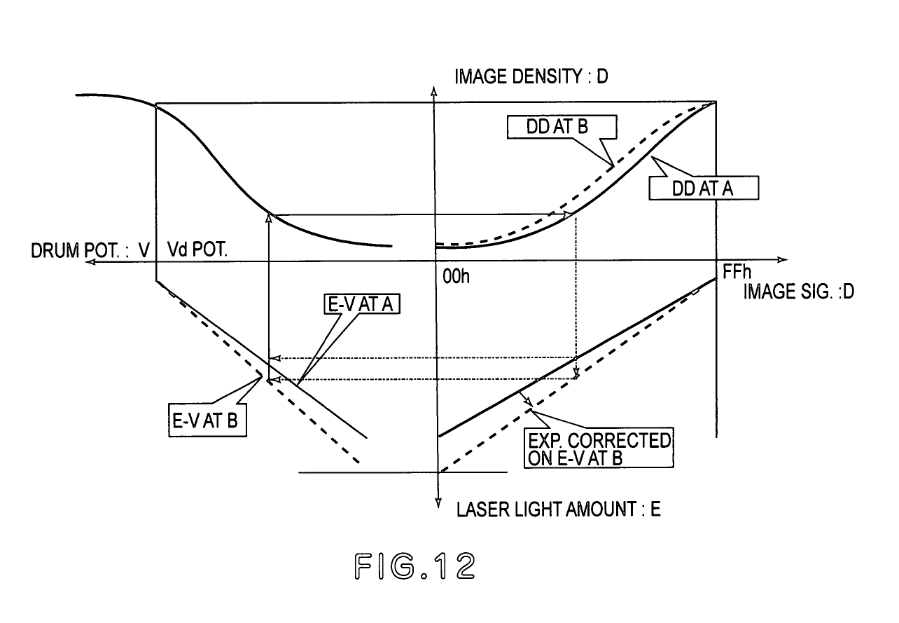

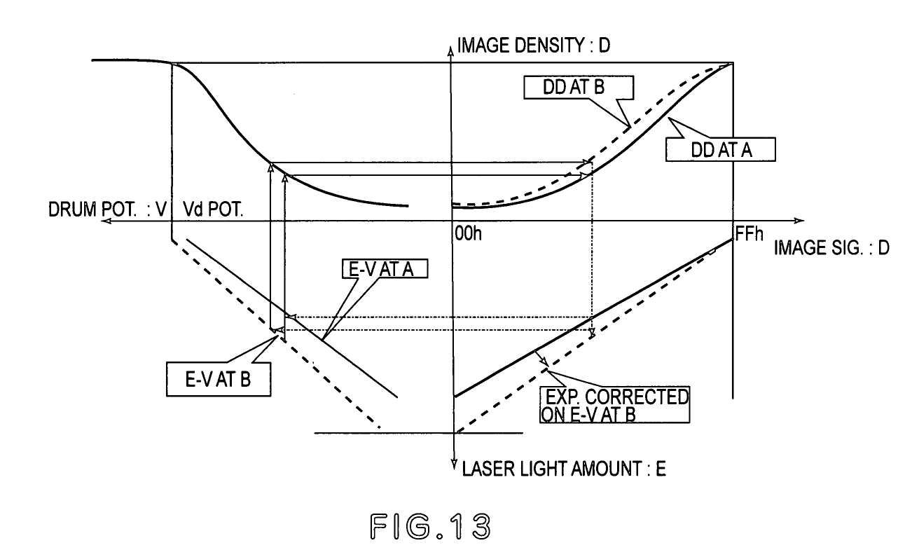

The photosensitive drum 1 is corrected in the VD potential level deviation, virtually at the same time as the photosensitive drum 1 is charged by the charging apparatus 2. In this embodiment, nine potential level sensors are disposed as the first potential level detecting means 11 of the potential level adjusting means 10, in the adjacencies of the photosensitive drum 1, downstream of the charging portion C and upstream of the exposing portion, in terms of the rotational direction R1. The nine potential level sensors are linearly distributed in the direction parallel to the axial line of the photosensitive drum 1. In other words, the image forming apparatus in this embodiment is provided with nine potential level measurement points aligned in the direction parallel to the axial line of the photosensitive drum 1. The greater the number of the measurement points, the higher the level of accuracy at which the nonuniformity in the potential level of the peripheral surface of the photosensitive drum 1 in terms of the direction parallel to the axial line of the photosensitive drum 1 is detected. However, it was discovered through the actual tests, the results of which are given in FIG. 9, that providing an image forming apparatus with roughly nine potential level measurement points aligned in the direction parallel to the axial line of the photosensitive drum 1 was sufficient for satisfactorily correcting the photosensitive drum 1 in potential level in terms of the direction parallel to the axial line of the photosensitive drum 1. The points at which the potential level of the peripheral surface of the photosensitive drum 1 is measured may be different from those in FIG. 9.

Next, the method for correcting the photosensitive drum 1 in the VD potential level will be described.

The method for correcting the photosensitive drum in the VD potential level will be described with reference to the case in which a corona discharger is employed as the charging apparatus 2 as described above.

The VD potential level of the peripheral surface of the photosensitive drum 1 is detected under various conditions in terms of the grid voltage, that is, the high voltage applied to the grid 2 of the charging apparatus 2.

The photosensitive drum 1 is corrected in the VD potential level, with the transmissivity of the variable transmissivity filter 13 set to the minimum level of transmissivity (darkest value in terms of light transmission), that is, under the condition under which the peripheral surface of the photosensitive drum 1 is not exposed, so that the VD potential level of the peripheral surface of the photosensitive drum 1 becomes the target level.

As for the target value for the VD potential level (target VD potential level), when the target value for the VD potential level (target VD potential level) at the fist potential level detecting means 11 is to be 500 V, the potential level of the peripheral surface of the photosensitive drum 1 is measured with the grid voltage set to 600 V, 800 V, and 900 V while rotating the photosensitive drum 1 once for each of 600 V, 800 V, and 900 V. Then, the correction is made so that the lowest potential level at each of the aforementioned nine potential level measurement points becomes slightly higher than the target VD voltage of 500 V. For example, when it is desired to achieve a target voltage of 500 V, a voltage of 550 V, that is, the sum of 500 V (target voltage) and 50 V (Δ50), which is slightly larger than the actual target value, is set as the tactical target value, in order to make it possible to adjust the peripheral surface of the photosensitive drum 1 in the VD potential level across the entirety of its functional range, by the beam of light projected from the LED as the light emitting portion 12, as it is turned on. In other words, the potential level of the peripheral surface of the photosensitive drum 1 can be reduced in absolute value by the beam of light projected from the light emitting portion 12 through the variable transmissivity filter 13, but cannot be increased in absolute value.

With the VD potential level set to a value slightly higher than the target value, the variable transmissivity filter 13 is reduced in steps in transmissivity.

In each step, the potential level of the peripheral surface of the photosensitive drum 1 is measured at each of the measurement points while rotating the photosensitive drum 1 once to obtain the average potential level of the peripheral surface of the photosensitive drum 1 at each measurement point. Then, the relationship between the thus obtained average potential value and the transmissivity of the variable transmissivity filter 13 in each step is stored in the storage means (unshown) of the image forming apparatus, making it possible to make correction for the deviation in potential level by the amount optimal for the transmissivity value set for the variable transmissivity filter 13 to make the photosensitive drum uniform in the VD potential level.

In this embodiment, the transmissivity distribution for the variable transmissivity filter 13 in terms of the direction parallel to the axial line of the photosensitive drum 1, which is used for correcting the photosensitive drum in the VD potential level is created based on the potential values obtained by measuring the potential level of the peripheral surface of the photosensitive drum 1 at the abovementioned nine measurement points.

The results of the measurement of the potential level of the peripheral surface of the photosensitive drum 1 by the first potential level detecting means 11 at the nine measurement points are transmitted by the transmissivity controlling means 15 to the computing portion (unshown) of the controlling means in the image forming apparatus, in which the transmimissivity value for each of the points of the variable transmissivity filter 13 corresponding to the nine measurement points, one for one, from the received results, that is, the relationship between the VD potential values obtained through the above described measurements, and the amount of the reduction in potential level attributable to the changes in the transmissivity of the variable transmissivity filter 13.

Then, the computed transmissivity values for the points of the variable transmissivity filter 13 corresponding to the measurement points are converted into a nonlinear transmissivity distribution data for the variable transmissivity filter 13 in terms of the direction parallel to the axial line of the photosensitive drum 1, and the data are transmitted to the driver circuit which individually controls, in transmissivity, each of the plural sections of the liquid crystal shutter. In response to these transmissivity mapping data, each section of the liquid crystal shutter in terms of the direction parallel to the axial line of the photosensitive drum 1 is instantly changed, correcting in real time the photosensitive drum in the VD potential level, in terms of the direction parallel to the drum axis, in response to the potential level detection.

In this embodiment, the transmissivity computing portion, that is, the controlling means for computing the transmissivity distribution for the liquid crystal shutter, based on the measured potential values of the peripheral surface of the photosensitive drum 1, is independent from the CPU for controlling the entirety of the image forming apparatus. In other words, the image forming apparatus is structured so that the transmissivity computing portion, that is, the transmissivity controlling means, controls only the transmissivity, being enabled to instantly control the liquid crystal shutter in transmissivity in response to the changes in the nonuniformity in potential level which occurs as the photosensitive drum 1 rotates.

By controlling the liquid shutter in transmissivity as described above, the amount by which the light is transmitted through the liquid crystal shutter to expose the peripheral surface of the photosensitive drum 1 is adjusted.

With the employment of the above described structural arrangement, the potential level of the peripheral surface of the photosensitive drum 1 is measured by the first potential level detecting means between the charging portion and exposing portion (between when photosensitive drum is charged and when photosensitive drum is exposed), and then, the photosensitive drum is adjusted in the level of the acquired potential by the potential level adjusting means located downstream of the first potential level detecting means. More specifically, the liquid crystal shutter is adjusted in transmissivity so that the portions of the liquid crystal shutter, which correspond in position to the portions of the peripheral surface of the photosensitive drum 1, which are high in potential level, transmit the exposure light by a larger amount to expose the peripheral surface of the photosensitive drum 1. As a result, the photosensitive drum 1 is adjusted in the level of the VD potential, becoming therefore uniform in the VD potential level in terms of the direction parallel to the drum axis. Thereafter, the peripheral surface of the photosensitive drum 1 is exposed; that is, the peripheral surface of the photosensitive drum 1 is exposed after being corrected in the VD potential level. Therefore, even if the peripheral surface of the photosensitive drum 1 is nonuniform in the VD potential level after the charging of the photosensitive drum 1 by the charging means, the portions of the peripheral surface of the photosensitive drum 1, which are deviant in potential level (VD potential level), are adjusted in potential level, before they reach the exposing portion. Therefore, the photosensitive drum 1 can be corrected in potential level, without the need for rotating the photosensitive drum just for correcting the photosensitive drum 1 in the VD potential level.

The following is another embodiment of the present invention.

Referring to FIG. 1, in this embodiment, the image forming apparatus is provided with a second potential level detecting means 16 as the means for detecting the post-exposure potential level of the peripheral surface of the photosensitive drum 1, which is disposed downstream of the exposing portion E and upstream of the developing portion D, in terms of the rotational direction of the photosensitive drum 1. With the provision of this structural arrangement, it is possible to make the peripheral surface of the photosensitive drum 1 uniform in the VL potential level. The portions of the image forming apparatus in this embodiment other than the second potential level detecting means 16 are identical to those in the preceding embodiment described above, and therefore, will not be described.

The second potential level detecting means 16 comprises a plurality of potential level sensors distributed in straight line, with the provision of predetermined intervals, in the direction parallel to the drum axis. Referring to FIG. 3, each of these potential level sensors is supported by the supporting member 17 so that it faces the peripheral surface of the photosensitive drum 1. These potential level sensors may be identical to those used as the parts of the first potential level detecting means in the first embodiment.

In this embodiment, in order to adjust the amount of the laser light projected from the exposing apparatus 3, the amount of the laser light projected from the exposing apparatus 3 for the photosensitive drum exposure is set to four different values. With the amount of the laser light set at each of the four values, the peripheral surface of the photosensitive drum 1 is exposed, and the VL potential level of the photosensitive drum 1 is measured by the second potential level detecting means 16, at a plurality of measurement points aligning, with the presence of the predetermined intervals, in the direction parallel to the drum axis, while rotating the photosensitive drum 1 once. Then, the average value of the VL potential of the point of the peripheral surface of the photosensitive drum 1 corresponding to each measurement point is obtained. To describe in detail the aforementioned four values at this time, the signal data for writing a latent image is expressed in 256 levels. The developing apparatus in this embodiment is of the normal development type. Therefore, when the signal data is zero, there will be no image. Therefore, when the signal data is zero, the amount of the exposure light is set to zero, or the minimum value. On the contrary, when the signal data is 255, that is, when the image formation data is maximum, the exposure light amount is set to the maximum value, or the closest to the maximum value. Thus, the four values 40, 80, 1560, and 255, in this embodiment, for the exposure light amount means that the peripheral surface of the photosensitive drum 1 is exposed to the exposure light, the amount of which corresponds to the signal data of 40, 80, 160, or 255. In this embodiment, the amount of the exposure laser light is set to the abovementioned four values as described above. However, it may be set to values different from the abovementioned four values. Incidentally, the relationship between the signal data and exposure amount in a reversal development system is obviously different from that in the normal development system.

The relationship between the average potential value of the peripheral surface of the photosensitive drum 1 at each of the measurement points, and the position of each measurement point in terms of the direction parallel to the drum axis, is tabulated and stored in the storage means (unshown) in the image forming apparatus. In this embodiment, when correcting the photosensitive drum in the VL potential level , that is, when achieving the predetermined VL potential level, the potential value as the referential value for the four exposure values is used as the potential value at the mid point of the photosensitive drum in terms of the direction parallel to the drum axis (mid point of drum in lengthwise direction).

The VL potential level for the image forming apparatus is obtained by subtracting from the VD potential value, the target latent image contrast potential difference (development contrast value+background (non-image) contrast value) determined according to such factors as ambience. The value to which the amount of the laser output is set is determined from the relation between the potential value detected by the second potential level detecting means located at the mid point of the peripheral surface of the photosensitive drum 1, and the amount of exposure laser light, so that the average value of the VL potential level becomes equal to the target value.

As for the axial potential level nonuniformity profile for achieving the target VL potential level, the average axial potential level distribution of the photosensitive drum for a single rotation of the photosensitive drum is created by interpolation, from the target VL potential level for the mid point of the photosensitive drum, and the referential axial potential level nonuniformity profile obtained with the use of the aforementioned four values for the exposure.

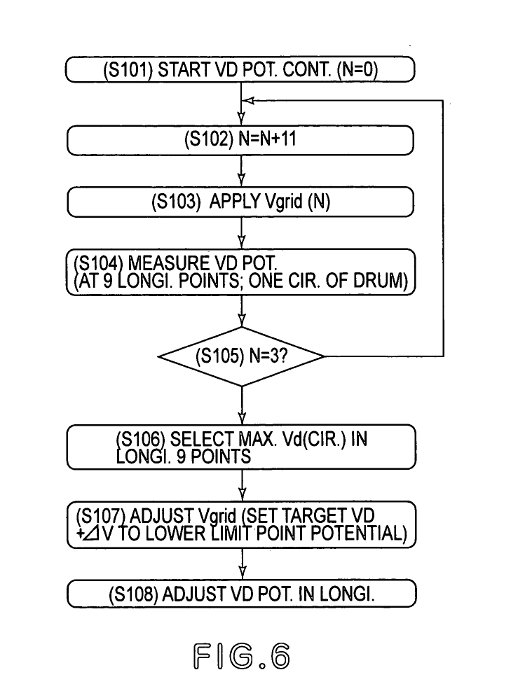

Referring to FIG. 5, as for the reason for correcting the photosensitive drum in post-exposure potential level, based on the average axial potential level distribution of the photosensitive drum calculated by rotating the photosensitive drum only once, in spite of the fact that the axial nonuniformity in the potential level of the photosensitive drum detected at the aforementioned measurement point varies as the photosensitive drum is rotated, is that the axial nonuniformity, in potential level, of the photosensitive drum results in the formation of images nonuniform in density, that is, images suffering from vertical lines and/or stripes which are substantially more conspicuous than the image defects resulting from the circumferential nonuniformity, in potential level, of the photosensitive drum.

At this time, the potential level control sequence in this embodiment will be described. This potential level control is carried out during the periods in which no image is actually formed, for example, the pre-rotation period, that is, the operational period between when the electrical power for the image forming apparatus is turned on and when the image forming apparatus becomes ready for actual image formation, or the post-rotation period.

During the abovementioned periods, the photosensitive drum 1 is adjusted in both the pre-exposure potential level (VD) and post-exposure potential level (VL).

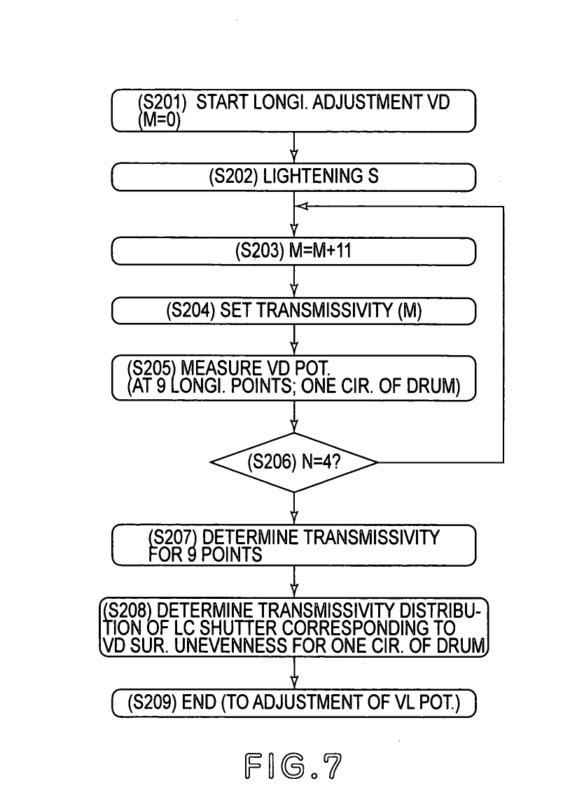

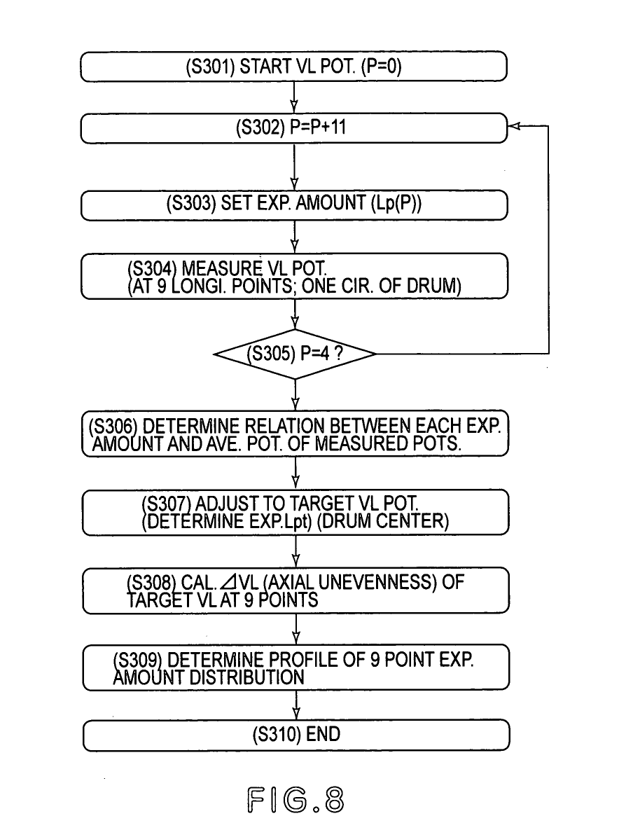

The flowchart in FIG. 6 is for adjusting the photosensitive drum 1 in pre-exposure potential level, on the charging device side. As the VD potential level adjustment is started (S101), it is determined how many times the adjustment has been made (S102). Then, voltage predetermined in potential level in accordance with the number of times the adjustment has been made, is applied to the grid of the corona discharger (S103), and the potential level of the peripheral surface of the photosensitive drum 1 is detected by the first potential level detecting means, at nine points in terms of the direction parallel to the lengthwise direction of the photosensitive drum 1, for the length of time equivalent to a single rotation of the photosensitive drum 1 while continuously applying the above described voltage to the grid of the corona discharger (S104). When the adjustment count is one, the potential level of the voltage applied to the grid is set to 600 V (Vgrid=600 V); when the adjustment count is two, it is set to 800 V (Vgrid=800 V); and when the adjustment count is three, it is set to 900 V (Vgrid=900 V) . As the adjustment count reaches three, the control advances to S106, whereas when the adjustment count is less than three, the control returns to S102. In S106, a value equal to, or slightly larger than, the value of the largest of the potential level deviations detected at the nine measurement points, is added as ΔV to the target pre-exposure potential level value (target VD value), obtaining the target pre-adjustment potential level value (VDtarget+ΔV), or the target potential level for the photosensitive drum 1 before the photosensitive drum 1 is adjusted in potential level by the potential level adjusting means. For example, if the target potential level for the photosensitive drum 1 is −500 V, and ΔV is −50 V, the target pre-adjustment potential level is −550 V. Thus, Vgrid is adjusted to achieve this target pre-exposure potential level. In this embodiment, the charging apparatus 2 is a corona discharger. Therefore, Vgrid is adjusted. But, when the charging apparatus 2 is of a different type, the voltage which affects the potential level to which the photosensitive drum 1 is charged is adjusted. After the adjustment of this voltage which affects the pre-adjustment potential level to which the photosensitive drum 1 is charged, the control advances to the step (S108), in which the photosensitive drum 1 is adjusted in potential level at the predetermined points in terms of the direction parallel to the lengthwise direction of the photosensitive drum 1, as shown in FIG. 7.

Next, referring to FIG. 7, the sequence for adjusting the photosensitive drum 1 in potential level at the predetermined points in terms of the lengthwise direction will be described. As the adjustment of the photosensitive drum 1 in the VD potential level in terms of the lengthwise direction is started (S201), the illuminating portion S as the potential level adjusting means is turned on to illuminate the portion of the photosensitive drum 1 having been charged under the adjusted charging condition (S202). Then, the transmissivity value is selected (S204) according to the adjustment count (S203). The VD potential level is measured with the transmissivity set at each of the selected values (S205). In S206, when the adjustment count is four, that is, after the completion of the measurement of the potential level under the four conditions corresponding to the four different transmissivity values, the control advances to S207, whereas when the adjustment count is smaller than four, the control returns to S203. In S207, the relationship between each of the selected transmissivity values and the corresponding decrease in potential level is obtained (S207). This relationship is used to create a transmissivity adjustment map for the VD potential level, which is correlated to the rotational phase of the photosensitive drum 1, and corresponds to the single rotation of the photosensitive drum 1 (S208). Then, the control advances to S209, in which the photosensitive drum 1 is adjusted in the post-exposure potential level (S209). With the transmissivity adjustment map corresponding to the single rotation of the photosensitive drum 1 created as described above, the photosensitive drum 1 can be made uniform in pre-exposure potential level. While this sequence is carried out, the photosensitive drum 1 is not exposed by the exposing means for image formation.

Through the sequences shown in FIGS. 6 and 7, the photosensitive drum 1 was made uniform with respect to the potential level at the exposure point. However, when the image formation exposure light is nonuniform in intensity in terms of the direction parallel to the drum axis, the photosensitive drum 1 becomes nonuniform in the post-exposure potential level (VL potential level). In this embodiment, therefore, in order to prevent the photosensitive drum 1 from becoming nonuniform in post-exposure potential level, the exposure light is adjusted in intensity. Next, referring to FIG. 9, the exposure light intensity adjustment sequence will be described. As the adjustment of the photosensitive drum 1 with respect to the VL potential level is started to make the photosensitive drum 1 uniform in the VL potential level in the lengthwise direction (S301), the adjustment count is obtained (S302), and the exposure amount is set in accordance with the adjustment count (S303). In this embodiment, the adjustment is to be made four times, and the photosensitive drum 1 is exposed by the amount predetermined in relation to the adjustment count and image signal data. That is, when the adjustment count is one, two, three, and four, the photosensitive drum 1 is exposed by the amounts proportional to image signal data of 40, 80, 160, and 255, respectively, and the VL potential levels corresponding to these exposure amounts are measured (S204). In S305, when the adjustment count is four, that is, after the completion of the measurement of the VL potential levels corresponding to the four different exposure amounts, the control advances to S306, whereas when the adjustment count is smaller than four, the control advances to S302. In S306, the relationship between the exposure amount and corresponding decrease in potential level is obtained. This relationship is used to determine the exposure amount for achieving the target VL potential level (S307). In this embodiment, nine second potential level detecting means are distributed in the lengthwise direction of the photosensitive drum 1. After an optimal value is set for the exposure amount, the exposing portion is adjusted in exposure amount across its functional range, for the nonuniformity in exposure light intensity (S308). With the employment of the above described method, the photosensitive drum 1 was minimized in the nonuniformity in the VD and VL potential level, in the lengthwise as well as circumferential directions.

Also in this embodiment, in order to control the photosensitive drum 1 in potential level, the potential level detecting means is disposed downstream of the charting point in terms of the rotational direction of the image bearing member, and the potential level adjusting means is disposed on the downstream of the potential level detecting means. Further, the exposing portion is disposed downstream of the potential level adjusting means. Therefore the interval between the potential level detecting position and potential level adjusting position is short, making it possible to control the photosensitive drum 1 in potential level in a short time, without wastefully rotating the photosensitive drum 1.

Incidentally, the exposing method employed in this embodiment is the background exposing method (BAE), which exposes the points of the peripheral surface of the photosensitive drum 1, which correspond to the background portions of an image, with the use of digitally processed video signals. Therefore, the photosensitive drum 1 is kept constant in development contrast potential level difference by adjusting the photosensitive drum 1 in the VD potential level with the use of the same VD potential level adjusting method as that in the first embodiment.

The laser is adjusted for each scanning line, in exposure amount across its scanning range, in accordance with the axial VL potential level nonuniformity profile, and with no relation to the video signals. By exposing the peripheral surface of the photosensitive drum 1 to the exposure light from the exposing means adjusted in exposure amount through this exposure amount adjustment process, the photosensitive drum 1 is made uniform in the VL potential level in terms of the direction parallel to the drum axis.

The development conditions change due to the changes which occur to the image forming apparatus (developing apparatus) with usage. However, according to this embodiment, if the development conditions change, the axial nonuniformity profile in the VL potential level, which is attributable to the changes in the development conditions, can be instantly computed, with the use of the referential data regarding the axial nonuniformity of the photosensitive drum 1 in the VL potential level, obtained by measuring the VL potential level of the photosensitive drum 1 with the laser intensity set to the abovementioned four values, and also, the VL potential level, at the midpoint of the photosensitive drum 1 in terms of the lengthwise direction, used as the referential potential level. Therefore, even if the potential level distribution changes, this embodiment can properly adapts to the changes in the axial nonuniformity of the photosensitive drum 1 in potential level.

As for the relationship between the exposure amount and potential level, which results as the photosensitive drum is changed in the VL potential level, the exposure amount is adjusted in accordance with the axial nonuniformity in sensitivity of the photosensitive drum, and the relationship between the exposure amount and the average circumferential VL potential level of the photosensitive drum 1 measured with the same timing as that with which the above described potential level control was carried out.

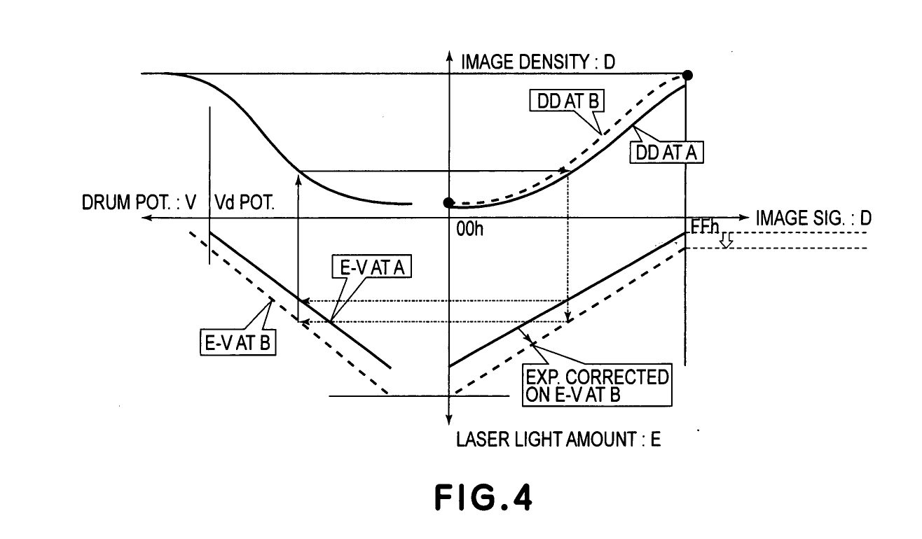

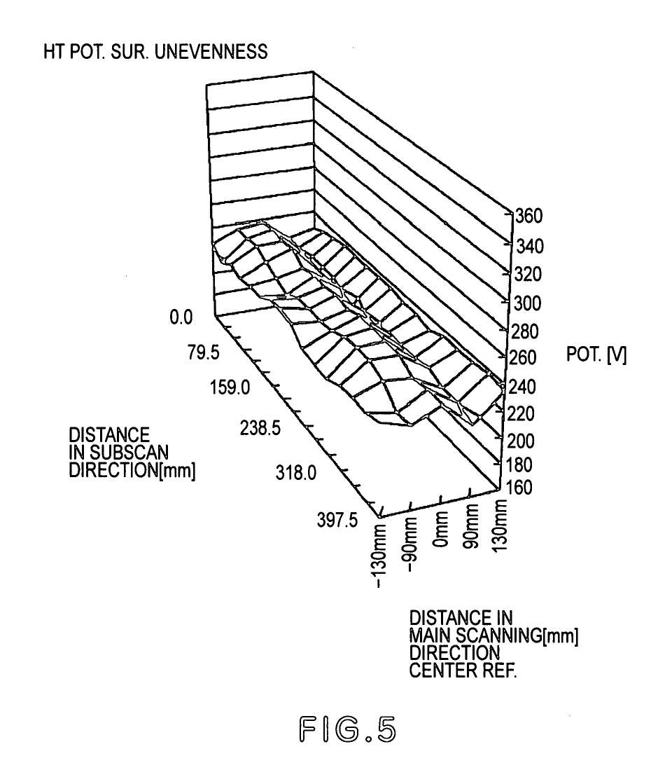

As a result, the photosensitive drum 1 is made uniform in both the VD and VL potential levels in terms of the direction parallel to the drum axis, as shown in to FIG. 4. With the photosensitive drum 1 made uniform in both the VD and VL potential levels, even if the photosensitive drum 1 is nonuniform in sensitivity (E-V characteristic) in terms of the direction parallel to the drum axis, the photosensitive drum 1 can be made uniform in the potential level which corresponds to the video signal representing the density level of the halftone, and therefore, the image forming apparatus can be kept constant in image density.

As long as the photosensitive drum is uniformed in potential level at the video signal level, the gradation adjustment control to be carried out in response to video signals can be properly carried out regardless of the position in terms of direction parallel to the drum axis.

As described above, the present invention can reduce the length of time between when the potential level of an image bearing member is detected after the charging of the image bearing member by a charging means, and when the image bearing member is adjusted in the potential level.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 091628/2004 filed Mar. 26, 2004, which is hereby incorporated by reference.

1. An image forming apparatus comprising:
a rotatable image bearing member;
charging means for electrically charging said image bearing member;
exposure means for exposing said image bearing member charged by said charging means to light at an exposure position to form an electrostatic latent image;
pre-exposure potential detecting means for detecting a potential on said image bearing member before exposure to the light, said pre-exposure potential detecting means being disposed at a position downstream of said charging means and upstream of the exposure position with respect to a rotational direction of said image bearing member; and
potential adjusting means for adjusting the potential on said image bearing member before the exposure on the basis of an output of said potential detecting means, said potential adjusting means being disposed downstream of said pre-exposure potential detecting means and upstream of the exposure position with respect to the rotational direction of said image bearing member.

2. An apparatus according to claim 1, further comprising first potential setting means for setting a first target potential for a position before said potential adjusting means for determining a charging condition of said charging means, and second potential setting means for setting a second target potential for a position before said exposure means for determining an adjustment condition for said potential adjusting means.

3. An apparatus according to claim 2, wherein the second setting potential is higher than the first setting potential.

4. An apparatus according to claim 1, wherein said potential adjusting means adjust the potential on said image bearing member by controlling an exposure amount of said image bearing member.

5. An apparatus according to claim 1, wherein said pre-exposure potential detecting means detects a potential at each of a plurality of positions substantially on a line perpendicular to a peripheral moving direction of said image bearing member.

6. An apparatus according to claim 1, wherein said potential adjusting means adjusts the potential on said image bearing member at a position before the image exposure during an image forming operation.

7. An apparatus according to claim 1, further comprising post-exposure potential detecting means for detecting the potential on image bearing member after the exposure, said post-exposure potential detecting means being disposed downstream of the exposure position with respect to the rotational direction of said image bearing member, and exposure adjusting means for adjusting an exposure intensity on the basis of output of said post-exposure potential detecting means.

8. An apparatus according to claim 2, wherein said exposure adjusting means adjusts the exposure intensity on the basis of the potential detected by said post-exposure potential detecting means.

9. An image forming apparatus comprising:
a rotatable image bearing member;
charging means for electrically charging said image bearing member;
exposure means for exposing said image bearing member charged by said charging means to light at an exposure position to form an electrostatic latent image;
pre-exposure potential detecting means for detecting a potential on said image bearing member before exposure to the light, said pre-exposure potential detecting means being disposed at a position downstream of said charging means and upstream of the exposure position with respect to a rotational direction of said image bearing member; and
post-exposure potential detecting means for detecting a potential on said image bearing member after exposure to the light, said post-exposre potential detecting means being disposed at a position downstream of the exposure position with respect to a rotational direction of said image bearing member.
